(19) United States
(12) Patent Application Publication
(10) Pub. No.: US 2007/0246374 A1
(43) Pub. Date: Oct. 25, 2007

(54) PERFORMANCE MANAGEMENT FOR INTEGRATED HYDROGEN SEPARATION AND COMPRESSION SYSTEMS

(75) Inventors: Glenn A. Eisman, Niskayuna, NY (US); Michael D. Gasda, West Sand Lake, NY (US)

Correspondence Address: H2 PUMP, LLC, 11 NORTHWAY LANE NORTH, LATHAM, NY, 12110, US

(73) Assignee: H2 Pump LLC, Latham, NY (US)

(21) Appl. No.: 11/737,737

(22) Filed: Apr. 19, 2007

Related U.S. Application Data
(60) Provisional application No. 60/793,499, filed on Apr. 20, 2006.

(51) Int. Cl. B01D 53/32; B01D 59/42

(52) U.S. Cl. 205/765; 204/520

(57) ABSTRACT

Apparatus and operating methods are provided for integrated electrochemical hydrogen separation and compression systems. In one possible embodiment, an electrical connection is initiated between an anode and a cathode of an electrochemical cell. Hydrogen is ionized at the anode to flow protons through a proton exchange membrane to the cathode. The protons are reacted with oxygen at the cathode to form water. The electrical connection between the anode and the cathode is removed, and a power supply is connected to the anode and cathode so that the anode has a higher electrical potential with respect to zero than the cathode. Various methods, features and system configurations are discussed.

### CROSS REFERENCE TO RELATED APPLICATION

This application claims priority under 35 USC 119(e) from U.S. Provisional Application No. 60/793,499, filed Apr. 20, 2006, naming Gasda and Eisman as inventors, and titled “MEANS OF PROTECTING THE POWER SUPPLY IN A HYDROGEN PUMPING SYSTEM.” This application is hereby incorporated herein by reference in their entirety and for all purposes.

### TECHNICAL FIELD OF THE INVENTION

The present invention relates to apparatus and operating methods for electrochemical hydrogen separation and compression systems. Various methods, features and system configurations are discussed.

### BACKGROUND

Electrochemical technologies are of increasing interest, due in part to advantages provided in efficiency and environmental impact over traditional mechanical and combustion based technologies.

A variety of electrochemical fuel cell technologies are known, wherein electrical power is produced by reacting a fuel such as hydrogen in an electrochemical cell to produce a flow of electrons across the cell, thus providing an electrical current. For example, in fuel cells utilizing proton exchange membrane technology, an electrically non-conducting proton exchange membrane is typically sandwiched between two catalyzed electrodes. One of the electrodes, typically referred to as the anode, is contacted with hydrogen. The catalyst at the anode serves to divide the hydrogen molecules into their respective protons and electrons. Each hydrogen molecule produces two protons which pass through the membrane to the other electrode, typically referred to as the cathode. The protons at the cathode react with oxygen to form water, and the residual electrons at the anode travel through an electrically conductive path around the membrane to produce an electrical current from anode to cathode. The technology is closely analogous to conventional battery technology.

Electrochemical cells can also be used to selectively transfer (or “pump”) hydrogen from one side of the cell to another. For example, in a cell utilizing a proton exchange membrane, the membrane is sandwiched between a first electrode (anode) and a second electrode (cathode), a gas containing hydrogen is placed at the first electrode, and an electric potential is placed between the first and second electrodes, the potential at the first electrode with respect to ground (or “zero”) being greater than the potential at the second electrode with respect to ground. Each hydrogen molecule reacted at the first electrode produces two protons which pass through the membrane to the second electrode of the cell, where they are rejoined by two electrons to form a hydrogen molecule (sometimes referred to as “evolving hydrogen” at the electrode).

Electrochemical cells used in this manner are sometimes referred to as hydrogen pumps. In addition to providing controlled transfer of hydrogen across the cell, hydrogen pumps can also by used to separate hydrogen from gas mixtures containing other components. Where the hydrogen is pumped into a confined space, such cells can be used to compress the hydrogen, at very high pressures in some cases.

There is a continuing need for apparatus, methods and applications relating to electrochemical cells.

### SUMMARY OF THE INVENTION

Apparatus and operating methods are provided for integrated electrochemical hydrogen separation and compression systems. In one possible embodiment, an electrical connection is initiated between an anode and a cathode of an electrochemical cell. Hydrogen is ionized at the anode to flow protons through a proton exchange membrane to the cathode. The protons are reacted with oxygen at the cathode to form water. The electrical connection between the anode and the cathode is removed, and a power supply is connected to the anode and cathode so that the anode has a higher electrical potential with respect to zero than the cathode. Numerous optional features and system configurations are provided.

Various aspects and features of the invention will be apparent from the following Detailed Description and from the Claims.

### DETAILED DESCRIPTION OF THE INVENTION

It will be appreciated that the apparatus, methods, and applications of the invention can include any of the features described herein, either alone or in combination.

Upon startup of an electrochemical hydrogen pumping cell, as hydrogen is introduced into the anode plenum, a large negative open cell voltage can be present if any air is present at the cathode. Such a condition can damage a power supply when it is connected to initiate pumping. This voltage is considered “negative” using the convention that voltage during ordinary pumping operation is positive. As an example, in a stack configuration consisting of multiple cells in series, the negative open cell voltage can be additive (e.g., 1 volt per cell in a 100 cell stack could amount to a 100 volt charge). The invention thus provides various configurations for protecting an electrochemical hydrogen pumping system power supply.

In one aspect, the invention provides a method of operating an electrochemical hydrogen pumping cell, including at least the following steps: initiating an electrical connection between an anode and a cathode of the cell; ionizing hydrogen at the anode to flow protons through a proton exchange membrane to the cathode; reacting the protons with oxygen at the cathode to form water; removing the electrical connection between the anode and the cathode; and connecting a power supply to the anode and cathode, wherein the anode has a higher electrical potential with respect to zero than the cathode.

In this context, the “electrical connection” between the anode and cathode can be any connection allowing current flow between the electrode, such as a short or an electrical load such as a resistor or other circuit capable of receiving current flow. The effect of the electrical connection is to cause the cell to operate as a fuel cell such that oxygen at the cathode is reacted to form water until oxygen at the cathode is consumed. As an example, such oxygen can be present as air that might leak or diffuse into the cell during manufacture or storage. When the oxygen is removed and there is no longer a threat of a negative open cell voltage, the power supply is connected to the cell so that electrochemical pumping can be initiated.

Methods under the present invention can include the step of flowing hydrogen across the anode while the electrical connection is present between the anode and cathode. It can be useful to provide excess hydrogen at the anode during operation of the cell in a fuel cell mode to avoid an anode fuel starvation situation where the anode materials can be oxidized.

In some embodiments, methods can include measuring a voltage between the anode and cathode; and performing a step of (removing the electrical connection between the anode and the cathode) when the voltage reaches a predetermined value.

In some embodiments, methods can include measuring a voltage between the anode and cathode; and performing a step of (connecting a power supply to the anode and cathode) when the voltage reaches a predetermined value.

In some embodiments, methods can include measuring a voltage between the anode and cathode; and performing a step of (connecting a power supply to the anode and cathode) when the electrical potential of the anode is higher with respect to zero than the cathode.

In another embodiment, the invention provides a method of operating an electrochemical hydrogen pumping cell, including at least the following steps: flowing a gas through a cathode of the cell, wherein the gas is selected from the group consisting of hydrogen and inert gases; contacting an anode of the cell with hydrogen; and connecting a power supply to the anode and cathode, wherein the anode has a higher electrical potential with respect to zero than the cathode. In this embodiment, the cathode plenum is flushed to remove any air or oxygen that may be present prior to initiation of electrochemical pumping. In this context, “inert” refers to any gas that will not react when injected into the cathode plenum.

In another embodiment, the invention provides a method of operating an electrochemical hydrogen pumping cell, including at least the following steps: contacting an anode of the cell with hydrogen; flowing electrical current across the cell to evolve hydrogen at the cathode; isolating the cell from the electrical current; and isolating the cathode from ambient air. As another example, embodiments may include a valve adapted to isolate the cathode from backflow of ambient air.

In addition to methods of operation, the invention also provides integrated systems suitable for use with such methods. In one embodiment, the invention provides an electrochemical hydrogen pumping system, comprising: an electrochemical cell comprising an anode and a cathode; a power supply adapted to flow electrical current across the cell; and a shorting mechanism adapted to selectively provide an electrical connection between the anode and cathode. In this context, “shorting mechanism” refers to any mechanical or electronic means of providing an electrical connection between the anode and cathode. This includes manual or automatic use of mechanical or electronic switches, applying a conductive member or circuit across the electrodes, applying a load, etc.

Embodiments may include a controller adapted to selectively activate such a shorting mechanism. Embodiments may also include a controller adapted to measure an electrical potential between the anode and cathode; wherein the controller is further adapted to selectively activate the shorting mechanism when the electrical potential reaches a predetermined value. As an example, the “predetermined value” can be zero, or any potential representing a condition where negative open cell voltage is not a threat to a system power supply that will be applied to initiate electrochemical pumping.

Suitable electrochemical hydrogen pumping cell technologies are well known, such as described in the teachings of U.S. Pat. Nos. 4,620,914; 6,280,865; 7,132,182 and published U.S. patent application Ser. Nos. 10/478,852 and 11/696,179. In certain embodiments, the proton exchange membranes used under the present invention can include those based on polybenzimidazole (“PBI”) materials. Where such “high temperature” membranes are used, it is generally desirable to maintain them at an operating temperature of at least 100 C, such as 140 C or higher, or 160 C or higher.

Where PBI membranes are used, it is generally desirable to initiate operation with a membrane imbibed with phosphoric acid at a ratio of at least 20 moles phosphoric acid to polybenzimidazole repeating unit, or greater than 32 moles phosphoric acid to polybenzimidazole repeating unit, or even at least 40 moles phosphoric acid to polybenzimidazole repeating unit. It is also generally preferable that PBI materials be those formed from the sol-gel process. One advantage of PBI-based membranes is that they can generally be operated on dry gasses, where membranes such as Nafion® required humidification. In the context of the present invention, reference may be made to dry hydrogen source gas, or hydrogen source gas having less than 5% relative humidity (e.g., at the operating temperature of the cell), which is sometimes used to distinguish gasses that may not be completely dry, but are still too dry for use with membranes such as Nafion® that require humidification.

It is also generally preferable to use a proton exchange membrane having a proton conductivity that is as high as possible. For example, membranes preferred under the present invention are generally those having a proton conductivity of at least 0.1 S/cm, including those having a proton conductivity of at least 0.2 S/cm. Other proton exchange membranes can also be used with the present invention, such as Nafion®, PEEK, etc.

In order to maintain cell temperature, as is the case where high temperature cell membranes are used, some embodiments of the present invention may include a heater adapted to raise a temperature of the cell; and a controller adapted to measure a temperature of the cell; wherein the controller is further adapted to selectively activate the heater to maintain the temperature of the cell above a predetermined threshold.

Embodiments may also include a cathode gas injection port. For example, such a port may be used to inject hydrogen or an inert gas into the cathode plenum as described above. As another example, some embodiments may include a source gas selected from the group consisting of hydrogen and inert gases; a cathode gas injection port in fluid communication with the source gas and the cathode; and a controller adapted to contact the cathode with the source gas.

In another embodiment, an electrochemical hydrogen pumping system is provided that includes an electrochemical cell comprising an anode and a cathode; a power supply adapted to flow electrical current across the cell; and a diode adapted to prevent current backflow from the anode to the power supply. In alternative embodiments, the diode in such a configuration can be substituted with any device suitable for preventing current back flow.

In another embodiment, an electrochemical hydrogen pumping system is provided that includes an electrochemical cell comprising an anode and a cathode; a power supply adapted to flow electrical current across the cell; and wherein the anode comprises an oxidation resistant catalyst. As an example, the oxidation resistant catalyst can comprise platinum. Alternative embodiments can consist essentially of platinum, or consist entirely of pure platinum. As another example, the oxidation resistant catalyst can be configured to contain less than 0.1% carbon on a molar basis. Without wishing to be bound by theory, it is believed that carbon present in an electrode can oxidize in various circumstances, resulting in damage to the electrodes. For example, where an oxidation resistant catalyst is used for the anode, a pumping cell used in a fuel cell mode, as described above, can be subject to a fuel starvation condition without damaging the electrode by oxidation.

Whereas the embodiments and features discussed herein are generally described with respect to individual electrochemical cells, it will be appreciated that they are also applicable to cells grouped in stack configurations. Descriptions and claims as to the configuration and operation of individual cells can thus be taken to cover cells by themselves, or a cell forming part of a stack configuration.

The inventive concepts discussed in the claims build on traditional electrochemical cells technologies that are well known in the art. As examples, various suitable designs and operating methods that can be used as a base to implement the present invention are described in the teachings of U.S. Pat. Nos. 4,620,914; 6,280,865; 7,132,182 and published U.S. patent application Ser. Nos. 10/478,852 and 11/696,179, which are each hereby incorporated by reference in their entirety.

While the invention has been shown or described in only some of its forms, it should be apparent to those skilled in the art that it is not so limited, but is susceptible to various changes without departing from the scope of the invention.

We claim:

1. A method of operating an electrochemical hydrogen pumping cell, comprising:
initiating an electrical connection between an anode and a cathode of the cell;
ionizing hydrogen at the anode to flow protons through a proton exchange membrane to the cathode;
reacting the protons with oxygen at the cathode to form water;
removing the electrical connection between the anode and the cathode; and
connecting a power supply to the anode and cathode, wherein the anode has a higher electrical potential with respect to zero than the cathode.

2. The method of claim 1, further comprising:
flowing hydrogen across the anode while the electrical connection is present between the anode and cathode.

3. The method of claim 1, wherein the electrical connection between the anode and cathode comprises an electrical load.

4. The method of claim 1, further comprising:
measuring a voltage between the anode and cathode;
performing the step of (removing the electrical connection between the anode and the cathode) when the voltage reaches a predetermined value.

5. The method of claim 1, further comprising:
measuring a voltage between the anode and cathode;
performing the step of (connecting a power supply to the anode and cathode) when the voltage reaches a predetermined value.

6. The method of claim 1, further comprising:
measuring a voltage between the anode and cathode;
performing the step of (connecting a power supply to the anode and cathode) when the electrical potential of the anode is higher with respect to zero than the cathode.

7. A method of operating an electrochemical hydrogen pumping cell, comprising:
flowing a gas through a cathode of the cell, wherein the gas is selected from the group consisting of hydrogen and inert gases;
contacting an anode of the cell with hydrogen; and
connecting a power supply to the anode and cathode, wherein the anode has a higher electrical potential with respect to zero than the cathode.

8. The method of claim 7, further comprising:
measuring a voltage between the anode and cathode;
wherein the step of (connecting a power supply to the anode and cathode) is performed when the voltage reaches a predetermined value.

9. A method of operating an electrochemical hydrogen pumping cell, comprising:
contacting an anode of the cell with hydrogen;
flowing electrical current across the cell to evolve hydrogen at the cathode;
isolating the cell from the electrical current; and
isolating the cathode from ambient air.

10. An electrochemical hydrogen pumping system, comprising:
an electrochemical cell comprising an anode and a cathode;
a power supply adapted to flow electrical current across the cell; and
a shorting mechanism adapted to selectively provide an electrical connection between the anode and cathode.

11. The system of claim 10, further comprising:
a controller adapted to selectively activate the shorting mechanism.

12. The system of claim 10, further comprising:
a controller adapted to measure an electrical potential between the anode and cathode; and
wherein the controller is further adapted to selectively activate the shorting mechanism when the electrical potential reaches a predetermined value.

13. The system of claim 10, further comprising:
a heater adapted to raise a temperature of the cell;
a controller adapted to measure a temperature of the cell; and
wherein the controller is further adapted to selectively activate the heater to maintain the temperature of the cell above a predetermined threshold.

14. The system of claim 10, further comprising a cathode gas injection port.

15. The system of claim 10, further comprising:
a source gas selected from the group consisting of hydrogen and inert gases;
a cathode gas injection port in fluid communication with the source gas and the cathode; and
a controller adapted to contact the cathode with the source gas.

16. The system of claim 10, wherein the shorting mechanism comprises an electrical load.

17. An electrochemical hydrogen pumping system, comprising:
an electrochemical cell comprising an anode and a cathode; and
wherein the cell further comprises a cathode gas injection port.

18. The system of claim 17, further comprising:
a power supply adapted to flow electrical current across the cell; and
a shorting mechanism adapted to selectively provide an electrical connection between the anode and cathode.

19. The system of claim 17, further comprising:
a power supply adapted to flow electrical current across the cell;
a shorting mechanism adapted to selectively provide an electrical connection between the anode and cathode; and
wherein the shorting mechanism comprises an electrical load.

20. The system of claim 17, further comprising:
a power supply adapted to flow electrical current across the cell;
a shorting mechanism adapted to selectively provide an electrical connection between the anode and cathode; and
a controller adapted to selectively activate the shorting mechanism.

21. The system of claim 17, further comprising:
a power supply adapted to flow electrical current across the cell;
a shorting mechanism adapted to selectively provide an electrical connection between the anode and cathode;
a controller adapted to measure an electrical potential between the anode and cathode; and
wherein the controller is further adapted to selectively activate the shorting mechanism when the electrical potential reaches a predetermined value.

22. The system of claim 17, further comprising:
a heater adapted to raise a temperature of the cell;
a controller adapted to measure a temperature of the cell; and
wherein the controller is further adapted to selectively activate the heater to maintain the temperature of the cell above a predetermined threshold.

23. The system of claim 17, further comprising:
a source gas selected from the group consisting of hydrogen and inert gases;
wherein the cathode gas injection port is in fluid communication with the source gas and the cathode; and
a controller adapted to contact the cathode with the source gas.

24. An electrochemical hydrogen pumping system, comprising:
an electrochemical cell comprising an anode and a cathode; and
wherein the cell further comprises a valve adapted to isolate the cathode from backflow of ambient air.

25. The system of claim 24, further comprising:
a power supply adapted to flow electrical current across the cell; and
a shorting mechanism adapted to selectively provide an electrical connection between the anode and cathode.

26. The system of claim 24, further comprising:
a power supply adapted to flow electrical current across the cell;
a shorting mechanism adapted to selectively provide an electrical connection between the anode and cathode; and
wherein the shorting mechanism comprises an electrical load.

27. The system of claim 24, further comprising:
a power supply adapted to flow electrical current across the cell;
a shorting mechanism adapted to selectively provide an electrical connection between the anode and cathode; and
a controller adapted to selectively activate the shorting mechanism.

28. The system of claim 24, further comprising:
a power supply adapted to flow electrical current across the cell;
a shorting mechanism adapted to selectively provide an electrical connection between the anode and cathode;
a controller adapted to measure an electrical potential between the anode and cathode; and
wherein the controller is further adapted to selectively activate the shorting mechanism when the electrical potential reaches a predetermined value.

29. The system of claim 24, further comprising:
a heater adapted to raise a temperature of the cell;
a controller adapted to measure a temperature of the cell; and
wherein the controller is further adapted to selectively activate the heater to maintain the temperature of the cell above a predetermined threshold.

30. The system of claim 24, further comprising:
a cathode gas injection port;
a source gas selected from the group consisting of hydrogen and inert gases;
wherein the cathode gas injection port is in fluid communication with the source gas and the cathode; and
a controller adapted to contact the cathode with the source gas.

31. An electrochemical hydrogen pumping system, comprising:
an electrochemical cell comprising an anode and a cathode;
a power supply adapted to flow electrical current across the cell; and
a diode adapted to prevent current backflow from the anode to the power supply.

32. An electrochemical hydrogen pumping system, comprising:
an electrochemical cell comprising an anode and a cathode;
a power supply adapted to flow electrical current across the cell; and
wherein the anode comprises an oxidation resistant catalyst.

33. The system of claim 32, wherein the oxidation resistant catalyst comprises platinum.

34. The system of claim 32, wherein the oxidation resistant catalyst contains less than 0.1% carbon on a molar basis.
